(19) United States
(12) Patent Application Publication
(10) Pub. No.: US 2006/0027321 A1
(43) Pub. Date: Feb. 9, 2006

(54) Adhesive composition

(75) Inventors: Kevin R. Schaffer, Woodbury, MN (US); Dong-Wei Zhu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/914,773

(22) Filed: Aug. 9, 2004

(51) Int. Cl. B32B 37/00

(52) U.S. Cl. 156/330.9; 156/272.2

(57) ABSTRACT

The invention relates to an adhesive composition comprising the reaction product of at least one nitrogen-containing polymer and at least one polymerizable ethylenically unsaturated diluent.

### BACKGROUND

WO 00/75560 describes optical laminated bodies, lighting equipment and area luminescence equipment. The laminated optical body comprises a polarizing layer, a first transparent film disposed closely to a front surface of the polarizing layer, and a second transparent film disposed closely to a back surface of the polarizing layer, the polarizing layer comprises a reflective polarizing film, and both of the first transparent film and the second transparent film are diffusive films.

Industry would find advantage in alternative laminated optical articles, particularly such articles having improved properties.

### SUMMARY

The invention relates to an adhesive composition comprising the reaction product of at least one nitrogen-containing polymer and at least one polymerizable ethylenically unsaturated diluent.

The nitrogen-containing polymer is preferably a homopolymer or copolymer of a moderately polar Lewis base-functional monomer. The nitrogen-containing polymer is preferably soluble in the diluent. Suitable nitrogen-containing polymers include homopolymers and copolymers of vinylcaprolactam, ethyloxazoline homopolymers, vinylpyrrolidone copolymers, acrylonitrile-styrene copolymers, acrylonitrile-butadiene-styrene copolymers, (meth)acrylates polymers containing (e.g. pendant) nitrogen-containing moieties, and mixtures thereof. The nitrogen-containing polymer is typically free of ethylenically unsaturated polymerizable groups. The adhesive composition typically has a nitrogen-containing residual monomer content of less than 25 ppm.

The ethylenically unsaturated polymerizable diluent of the adhesive composition typically comprises at least one (meth)acrylate group. The ethylenically unsaturated polymerizable diluent may comprise a monomer, oligomer, prepolymer, or mixtures thereof. The amount of ethylenically unsaturated polymerizable diluent typically ranges from about 40 wt-% to about 98 wt-%. The adhesive composition may further comprise at least one crosslinking agent, particularly when the diluent is monofunctional. The adhesive composition typically comprises an initiator such as 0.1 wt-% to about 5 wt-% of a photoinitiator. The adhesive composition may be polymerized by photocuring.

The adhesive is particularly useful for bonding optical components such as optical films. The adhesive is suitable for bonding a wide variety of substrates including polymeric materials that are difficult to bond, such as PEN. The bond formed by the adhesive is of sufficient strength such that the T-peel is at least about 0.35 lbs/inch width (0.062 kg/cm width). In preferred embodiments, the adhesive is optically clear, exhibiting a refractive index ranging from about 1.50 to 1.55. The adhesive advantageously exhibits good stability, the change in b* (i.e. yellowness) of the adhesive is less than 2 after accelerated aging.

### BRIEF DESCRIPTION OF THE DRAWINGS

FIG. 1 is a cross-sectional view schematically showing an exemplary laminated optical article according to the present invention.

FIG. 2 schematically illustrates an embodied display unit.

### DETAILED DESCRIPTION

The recitation of numerical ranges by endpoint includes all number subsumed with that range (e.g. 1 to 5 includes 1, 1.5, 2, 2.75, 3, 3.80, 4 and 5).

As used herein, “laminated optical article” refers to an article comprising two optical films having an adhesive layer disposed between the optical films. An optical film as well as the laminated article has the ability to transmit light, e.g. such that an underlying display can be viewed. Various optical films are known in the art including for example polarizing films, prism films such as brightness enhancing films and turning films, diffusive films, as well as light guides and transparent surface protective layers. Other optical articles, such as intermediates, may include a single optical film and an adhesive layer.

Optical films have varying degrees of transparency depending on the intended function of such film. Although optical films may be comprised of glass or ceramic materials, optical films are commonly comprised of light transmissive polymeric materials including for example cellulose acetate butyrate, cellulose acetate propionate, cellulose triacetate, polyether sulfone, polymethyl methacrylate, polyurethane, polyester, polycarbonate, polyvinyl chloride, syndiotactic polystyrene, cyclic olefin copolymers, polyethylene naphthalate, and copolymers or blends based on naphthalene dicarboxylic acids. Optionally, the optical film can contain suitable mixtures or combinations of these materials.

In some preferred embodiments, the invention relates to optical articles and in particular laminated optical articles having improved properties. The improved properties are attributed to the selection of the adhesive composition.

In one aspect, the (e.g. laminated) optical article exhibits improved stability. By selection of an adhesive composition that is sufficiently stable the (e.g. laminated) optical article does not appreciably yellow with aging. For example, it has been found that the (e.g. laminated) optical article exhibits a change in yellowness color in the 1976 CIE L* a* b* color space, b* (t-0), of less than 2.0 when measured using a BYK Gardner Colorsphere (400 nm to 700 nm spectra) after accelerated aging. Accelerated aging was conducted by exposing the samples to spectral irradiance for 300 hours at a panel temperature of 90° C. with use of a device commercially available from Q-Panel Lab Products, Cleveland, Ohio equipped with a fluorescent ultraviolet lamp commercially available from Philips Lighting Co., Somerset, N.J. under the trade designation “Philips F 40/50U/ALTO Lamps”. Preferably, the change in yellowness, b*, is less than 1.5 and more preferably less than 1.0 after such accelerated aging. Non-yellowing behavior is particularly useful for liquid crystal displays such as televisions having direct lighting. Accordingly, the adhesive composition is suitable to bonding various optical films as well as other optical components that are typically employed in LCSs such as transparent plates and diffusive plates.

The adhesive is chosen in order that a bond of sufficient strength is formed with the substrate (e.g. optical film(s)) to which the adhesive is applied. The efficacy of a laminate having a first substrate (e.g. optical film) bonded to a second substrate (e.g. optical film) by means of the adhesive can be evaluated in various manners. One suitable method of evaluating the bond strength is T-peel adhesion, such method described in further detail in the examples. When this test is employed, it is preferred that the average T-peel is equal to or greater than the internal strength of the substrate. For example, the T-peel strength is preferably at least about 0.35 lbs/inch width (0.062 kg/cm width) when a bond is formed with a film (e.g. comprising PEN) and having a thickness of about 5 mils (0.127 mm). In at least some embodiments the average T-peel value is at least 0.5 lbs/inch width (0.089 kg/cm width) such as at least I lbs/inch width (0.18 kg/cm width), 2 lbs/inch width (0.35 kg/cm width), 3 lbs/inch width (0.53 kg/cm width), 4 lbs/inch width (0.71 kg/cm width), 5 lbs/inch width (0.89 kg/cm width), 6 lbs/inch width (1.1 kg/cm width), or 7 lbs/inch width (1.24 kg/cm width).

In addition to any one or combination of the properties just described, the adhesive composition has other properties that are particularly amendable for bonding optical films. In one aspect, the adhesive exhibits sufficient initial transparency such the presence of the adhesive does not diminish the optical properties of the optical film to which it was applied. Accordingly, the initial transmission, initial haze and initial gain are substantially the same as the optical film alone. The adhesive composition is preferably substantially stable such that the transmission, haze and gain are substantially the same after aging.

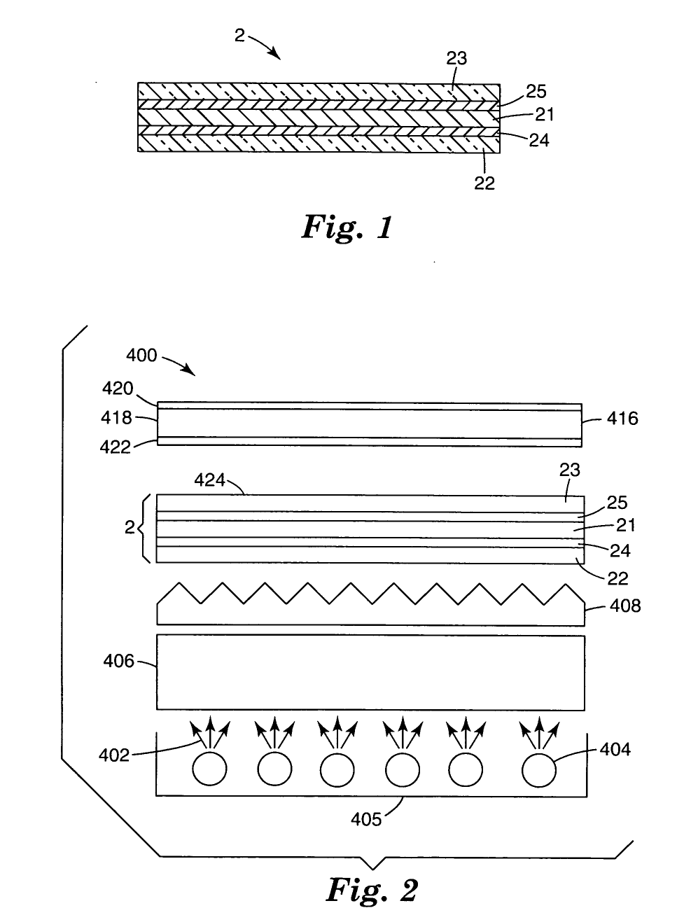

Although the adhesive described herein is suitable for bonding any first optical film to a second (i.e. same or different than the first) optical film, one exemplary preferred laminated optical article is depicted in FIG. 1. Such laminated optical article (2) comprises a polarizing layer (21) disposed between a first optical film (22) and a second optical film (23). Each of the optical films are bonded to the polarizing layer with adhesive layers (24) and (25).

At least some of the laminated optical articles, such as wherein the first and second optical films are both diffusive films, exhibit certain improved properties. In one aspect, this optical article exhibits improved stiffness. Such laminated optical article preferably have a stiffness of at least 65 lbs-force per inch width per inch thickness, as measured according to ASTM D790, as described in further detail in the examples. In some aspects, the stiffness is at least 80 lbs-force per inch width per inch thickness, at least 100 lbs-force per inch width per inch thickness, or at least 120 lbs-force per inch width per inch thickness. Employing an adhesive composition with a higher stiffness is amenable to reducing the thickness of the optical film layer such as the polarizing layer. Hence, in another aspect, the articles of the invention employ optical films of decreased thickness. For example the polarizing layer may have a thickness of less than 5 mils (0.127 mm) (e.g. less than 4.5 mils (0.114 mm), or less than 4 mils (0.102 mm). Accordingly, the laminated optical article may have a decreased thickness as well. The laminated optical article may have a thickness of less than about 500 microns, less than about 400 microns, or less than about 375 microns. The thickness is typically at least about 350 microns. Increased stiffness is also amenable for large-sized (e.g. liquid crystal) displays. In at least some embodiments, such article has comparable stiffness to the same article having a thicker polarizing film layer.

This particular laminated optical article also preferably exhibits certain optical properties. In one aspect, the laminated optical article typically exhibits an initial transmission of at least 35%, as measured with an instrument commercially available from BYK-Gardner USA, Columbia, Md. under the trade designation “BYK Gardner Colorsphere”. In preferred embodiments, the initial transmission is at least 40% and more preferably at least 45%. Alternatively or in addition thereto, in another aspect, the laminated optical article exhibits an initial haze of at least 60% as measured with an instrument also commercially available from BYK-Gardner USA, Columbia, Md. under the trade designation “BYK Gardner Haze-Guard Plus”. In preferred embodiments, the initial haze is at least 70% and more preferably at least 80%. Alternatively or in addition thereto, in another aspect, the laminated optical article exhibits a gain of at least 1.3. Gain, refers to the difference in transmitted light intensity of an optical material compared to a standard material as measured with a colorimeter commercially available from Photo Research, Inc, Chatsworth, Calif. under the trade designation “SpectraScan PR-650 SpectraColorimeter”. In preferred embodiments, the gain is at least 1.4, more preferably at least 1.5 and most preferably at least 1.6.

It is appreciated that the properties of an intermediate optical article (e.g. adhesive coated optical film) are at least equal to and may be better than the laminated optical article.

A preferred adhesive composition for providing any one or various combination of such properties comprises the reaction product of at least one nitrogen-containing polymer and at least one polymerizable ethylenically unsaturated diluent. The adhesive composition may optionally comprise other polymerizable and non-polymerizable ingredients as well.

The nitrogen-comprising polymer is surmised to act as an adhesion promoter. This aspect is particularly advantageous for bonding substrates (e.g. optical films) comprising PEN (e.g. surface layers). A variety of nitrogen-containing polymers can be employed in the adhesive composition of the invention. Nitrogen-containing polymers include homopolymers and copolymers of at least one moderately polar Lewis base-functional copolymerizable monomer. Polarity (e.g. hydrogen bonding ability) is frequently described by the use of terms such as “strongly”, “moderately” and, “poorly”. References describing these and other solubility terms include “Solvents paint testing manual”, 3rd ea., G. G. Seward, Ed., American Society for Testing and Materials, Philadelphia, Pa., and “A three-dimensional approach to solubility”, Journal of Paint Technology, Vol.38, No. 496, pp. 269-280.

Exemplary monomers include for example n-vinyl containing monomers such as vinyl-caprolactam and vinylpyrrolidone, (meth)acrylates monomers containing (e.g. pendant) nitrogen-containing moieties such as N,N-dimethylaminoethyl acrylate, as well as acrylonitrile. As used throughout, “(meth)acrylate” refers to both acrylate and methacrylate compounds. Ethyloxazoline is yet another suitable nitrogen-containing monomer.

The adhesive composition comprises one or more nitrogen-containing polymers, preferably present in an amount of at least about 2 wt-% (i.e. solids of the cured adhesive composition) of the adhesive composition and more preferably in an amount of at least about 5 wt-% such as at least 10 wt-%. Typically, the amount of nitrogen-containing polymer is no greater than about 60 wt-%. Preferably, the amount of nitrogen-containing polymer is no greater than about 50 wt-%, no greater than about 40 wt-%, or no greater than about 30 wt-%. Whereas sufficient amounts tend to improve adhesion particularly with PEN comprising substrates, excess nitrogen-containing polymer can cause a decrease in T-peel values. For preferred exemplified embodiments the adhesive composition is 100% solids and substantially free of solvent. After curing, the monomers are reacted into a polymer. The ratios of the monomer components of the polymer are the same ratios as the respective monomer mixture prior to curing.

Polymeric nitrogen-containing polymers typically lack polymerizable (e.g. ethylenically unsaturated) functional groups. Polymeric nitrogen-containing polymers also have a weight average molecular weight (Mw) greater than the monomeric species from which such polymer was prepared. Typically, nitrogen-containing polymers have a Mw of at least about 2,000 g/mole as measured for example with GPC with reference to polyethylene oxide standards. Often the Mw of the nitrogen-containing polymer is at least 5,000 g/mole (e.g. at least 10,000 g/mole). Although the Mw of various nitrogen-containing polymers may range up to about 1 million, typically the Mw is no greater than about 500,000 g/mole and often no greater than 100,000 g/mole. The nitrogen-containing polymers can also act as rheology modifiers in order that the final formulation has a suitable viscosity (e.g. 100-3000 cps) for the intended coating process. The use of nitrogen-containing polymers in lieu of monomeric adhesion promoters advantageously results in lower residual monomer content. For example, the residual nitrogen-containing monomer content of the (i.e. total) adhesive composition is typically less than 50 ppm, often less than 25 ppm, and preferably less than 10 ppm.

In preferred embodiments, particularly in the case of bonding optical films or other articles wherein the optical quality is of importance, the nitrogen-containing polymer is soluble in the adhesive composition. For embodiments wherein the adhesive composition consists essentially of two components, the nitrogen-containing polymer is soluble in the ethylenically unsaturated diluent. However, for adhesive compositions comprising other optional ingredients, the nitrogen-containing polymer is soluble in the mixture of the diluent in combination with such optional ingredients. By “soluble” it is meant that the polymer dissolves such that it forms an optically homogeneous transparent solution as can be detected by viewing the composition in a 3-inch diameter test tube. In addition to the adhesive compositions comprising soluble nitrogen-containing polymer(s) being homogeneous and transparent, such composition are also stable, meaning that the composition does not separate after 6 months or longer (e.g. 1-2 years) of storage at ambient temperature.

Preferred nitrogen-containing polymers due to their solubility (e.g. with monomers such as phenoxy ethyl acrylate) include homopolymers and copolymers of vinylcaprolactam, ethyloxazoline homopolymers, vinylpyrrolidone copolymers, acrylonitrile-styrene copolymers, acrylonitrile-butadiene-styrene copolymers, (meth)acrylates polymers containing pendant nitrogen-containing moieties such as amino moieties, as well as various mixtures thereof.

Suitable nitrogen-containing polymers may be polymerized (e.g. in-situ) prior to adding the remainder of the ingredients of the adhesive composition. Conveniently however, various nitrogen—containing polymers are commercially available from several sources. For example, copolymers of vinylpyrrolidone (PVP) and vinyl acetate (VA) are commercially available from International Specialties Products (Wayne, N.J.) under the trade designation “PVPNA” as well as from BASF (Mount Olive, N.J.) under the trade designations “Luviskol Va.” and “Kollidon”. Poly(vinylcaprolactam) homopolymers are commercially available from BASF under the trade designation “Luviskol Plus”. Further, a terpolymer of vinylpyrrolidone, vinylcaprolactam, and dimethylaminoethyl methacrylate is commercially available from International Specialty Products, Texas City, Tex. under the trade designation “Advantage S”. Linear polymers of ethyloxazoline and substituted ethyloxazoline are also commercially available from International Specialty Products under the trade designation “Aquazol”. Further, acrylonitrile-styrene copolymers and acrylonitrile-butadiene-styrene terpolymers are commercially available from Dow Chemicals, Midland, Mich. under the respective trade designation “Tyril” and “Magnum”. Although acrylonitrile based polymers provide adequate adhesion, at least some polymers have been found to contribute to yellowing of the adhesive.

The adhesive composition comprises at least one nitrogen-containing polymer in combination with at least one ethylenically unsaturated diluent. As used herein ethylenically unsaturated diluent refers to a monomer, oligomer, or prepolymer that comprises at least one ethylenically unsaturated polymerizable group and preferably is a liquid at ambient temperature. Various mixtures of monomer(s), oligomer(s), and/or prepolymer(s) may also be employed. Preferably, however, the oligomer or prepolymer is sufficiently low in molecular weight such that the viscosity of the adhesive composition does not exceed about 3,000 cps at ambient temperature after dissolution of the nitrogen-containing polymer. The diluent may be monofunctional or multifunctional (e.g. difunctional).

The total amount of ethylenically unsaturated diluent is typically at least about 30 wt-%, more typically at least about 50 wt-% and preferably at least about 70 wt-%. The total amount of ethylenically unsaturated diluent is preferably no greater than about 98 wt-%.

Although a variety of ethylenically unsaturated diluents may be employed, preferred monomers typically comprise acrylate group(s). Preferred ethylenically unsaturated diluents include esters of acrylic or methacrylic acid, such as, for example, octyl acrylate, isooctyl acrylate, 2-ethylhexyl acrylate, hydroxyethyl acrylate, decyl acrylate, lauryl acrylate, phenoxyethyl acrylate, hydroxyethyl acrylate; 2-(N,N-dimethylamino)ethyl acrylate, 4-(N,N-dimethylamino)butyl acrylate, hexanediol diacrylate, bisphenol A diacrylate, tri(propylene glycol) triacrylate, trimethylolpropane triacrylate, tetrahydrofurfuryl acrylate, polyethylene glycol diacrylate, and mixtures thereof.

Particularly in the case of laminated optical articles, the ethylenically unsaturated diluent typically has a refractive index of greater than 1.4. Suitable high index diluents include for example phenoxyethyl (meth)acrylate, phenoxy-2-methylethyl (meth)acrylate, phenoxyethoxyethyl (meth)acrylate, 3-hydroxy-2-hydroxypropyl (meth)acrylate, benzyl (meth)acrylate, 4-(1-methyl-1-phenethyl)phenoxyethyl (meth)acrylate and phenylthioethyl (meth)acrylate. Halogenated (e.g. brominated) diluents may be used as well.

The inclusion of only one diluent is preferred for ease in manufacturing. A preferred diluent is phenoxyethyl acrylate (PEA). Phenoxyethyl acrylate is commercially available from more than one source including from Sartomer, Exton, Pa. under the trade designation “SR339”; from Eternal Chemical Co. Ltd., Torrance, Calif. under the trade designation “Etermer 210”; and from CIBA under the trade designation “Ageflex PEA”; and from Cognis, Cincinnati, Ohio under the trade designation “Photomer 4035”. Alternatively, yet less preferred due to the residual nitrogen containing monomer content, the diluent may comprise nitrogen-containing moieties.

For embodiments wherein the ethylenically unsaturated diluent is monofunctional, it is preferred to employ a crosslinking agent comprising at least two ethylenically unsaturated polymerizable groups.

Multi-functional diluents can be used as crosslinking agents to increase the mechanical strength of the cured adhesive. One indication of an increase in mechanical strength is an increase in stiffness of the laminate, as previously described. The crosslinking agent comprises at least two and often three (meth)acrylate functional groups. Since methacrylate groups tend to be less reactive than acrylate groups, it is preferred that the crosslinking agent comprises two or more acrylate groups. Suitable crosslinking agents include for example pentaerythritol tri(meth)acrylate, pentaerythritol tetra(meth)acrylate, trimethylolpropane tri(methacrylate), dipentaerythritol penta(meth)acrylate, dipentaerythritol hexa(meth)acrylate, trimethylolpropane ethoxylate tri(meth)acrylate, glyceryl tri(meth)acrylate, pentaerythritol propoxylate tri(meth)acrylate, and ditrimethylolpropane tetra(meth)acrylate. Any one or combination of crosslinking agents may be employed.

Preferred crosslinking agents include for example ethoxylated bisphenol A diacrylate such as commercially available from Sartomer under the trade designation “Sartomer CD9038” as well as urethane acrylate such as commercially available from UCB Radcure, Smyrna, Ga. under the trade designation “Ebecryl 270”.

The crosslinking agent is preferably present in the polymerizable composition in an amount of at least about 2 wt-%. Typically, the amount of crosslinking agent is no greater than about 25 wt-%. The crosslinking agent may be present in any amount ranging from about 5 wt-% and about 15 wt-%.

The adhesive composition may optionally comprise one or more reactive (e.g. ethylenically unsaturated) ingredients and/or one or more non-reactive ingredients. Various additives such as solvent, chain transfer agents, colorants (e.g. dyes), antioxidants, light stabilizers, etc., can be added as are known in the art.

The adhesive described herein can be employed to bond a variety of substrates to produce a variety of coated substrates, intermediates, and (e.g. optical) articles. A particular advantage of the adhesive comprising a nitrogen-containing polymer (e.g. polymer) is the ability to bond surfaces comprising poly(ethylene naphthalate) (“PEN”). PEN is employed in various polymeric film materials either as a homopolymer or in combination with other polymeric materials as a copolymer. The amount of PEN of a copolymer is typically at least 10 wt-%, more commonly at least 20 wt-%, and more often at least about 50 wt-% (e.g. 75 wt-%). For embodiments wherein PEN copolymers are employed, it is appreciated that any amount of PEN can render the polymeric material more difficult to bond. For example polymeric materials comprising a copolymer of PEN and polyethylene terephthalate (PET) are more difficult to bond than polymeric materials comprising PET alone. It has been found that the adhesive described herein surprisingly exhibits good adhesion to film substrates comprising copolymers of PEN as well as good adhesion to substrates consisting entirely of PEN.

Since PEN comprising surfaces are appreciated as one of the more difficult polymeric material to bond, the adhesive described herein can also bond various other (e.g. polymeric) substrates and surfaces including for example various thermosetting or thermoplastic polymers such as polycarbonate, poly(meth)acrylate (e.g., polymethyl methacrylate or “PMMA”), polyolefins (e.g., polypropylene or “PP”), polyurethane, polyesters (e.g., polyethylene terephthalate or “PET”), polyamides, polyimides, phenolic resins, cellulose diacetate, cellulose triacetate, polystyrene, styrene-acrylonitrile copolymers, cyclic olefin copolymers, epoxies, and the like. Typically the substrate will be chosen based in part on the desired optical and mechanical properties for the intended use. Such mechanical properties typically will include flexibility, dimensional stability and impact resistance. The substrate thickness typically also will depend on the intended use. For most applications, substrate thicknesses of less than about 0.5 mm are preferred, and more preferably about 0.02 to about 0.2 mm. Although the substrate can optionally be treated to improve adhesion e.g., chemical treatment, corona treatment such as air or nitrogen corona, plasma, flame, or actinic radiation or an optional tie layer or primer could be applied, advantageously good adhesion is obtained in the absence of the substrate (e.g. optical film) including such treatments.

The adhesive composition is suitable for bonding non-polymeric materials such glass and ceramic. It is also surmised that the adhesive composition is suitable for bonding various metals.

Suitable methods of coating the adhesive composition onto a substrate include for example gap coating, bar coating, knife coating, gravure coating, die coating, curtain coating and other coating methods, as are known to one skilled in the art. Use of such coating methods provides a controlled adhesive thickness to the substrate. Suitable adhesive thicknesses that can be obtained by these methods are typically at least 0.25 mils. The adhesive thickness is typically no greater than 5 mils. If desired, thicker adhesive layers can be obtained by applying multiple coats of the adhesive to the substrate (each application followed by its own curing step) until the desired thickness is obtained.

Suitable methods of polymerizing the adhesive composition include for example solution polymerization and bulk polymerization, as are known in the art. Such polymerization methods include heating in the presence of a free-radical initiator as well as irradiation with electromagnetic radiation such as ultraviolet or visible light in the presence of a photoinitiator. Inhibitors are frequently used in the synthesis of the polymerizable composition to prevent premature polymerization of the resin during synthesis, transportation and storage. Suitable inhibitors include 4-methoxy phenol, and hindered amine nitroxide inhibitors at levels of 50-1000 ppm. Other kinds and/or amounts of inhibitors may be employed as known to those skilled in the art.

The composition of the present invention preferably comprises a least one photoinitiator. A single photoinitiator or blends thereof may be employed. In general the photoinitiator(s) are at least partially soluble (e.g. at the processing temperature of the resin) and substantially colorless after being polymerized. The photoinitiator may be (e.g. yellow) colored, provided that the photoinitiator is rendered substantially colorless after exposure to the UV light source.

For embodiments wherein the adhesive is polymerized by photocuring, a free radical or cationic photoinitiator is typically employed. Photoinitiators of the former type are, for example, benzophenone, 1-hydroxycyclohexyl phenyl ketone, isopropylthioxanthone, 2-hydroxy-2-methyl-l-phenylpropan-1 -one, 2-benzyl-2-dimethylamino-(4-morpholinophenyi)butan-1-one, benzil dimethylketal, bis(2,6-dimethylbenzoyl)-2,4,4-trimethylpentylphosphine oxide, 2,4,6-trimethylbenzoyidiphenylphosphine oxide, or a mixture thereof. Photoinitiators of this class are commercially available, for example, from Ciba Specialty Chemicals under the trade designations “Irgacure” and “Darocure”, from Rahn AG under the trade designation “Genocure”, and from BASF under the trade designation “Lucirin”. Photoinitiators of the cationic type are, for example, sulphonium or iodonium salts such as triphenylsulphoniurn hexafluoroantimonate or diphenyliodonium hexafluorophosphate. Colorless or nearly colorless materials are preferred. The photoinitiator is preferably present in a total amount of at least 0.1 wt-% (e.g. at least 0.25 wt-%, at least 0.5 wt-%). The amount of photoinitiator is typically less than 10 wt-% and preferably less than 5 wt-% of the adhesive composition.

Various polarizing layers are suitable for use in the laminated optical article of the invention, such as depicted in FIG. 1. A reflective polarizing film is a preferred polarizing layer for constructions wherein the polarizing layer (21) is disposed between a first diffusive optical film (22) and a second diffusive optical film (23).

The reflective polarizing film is preferably a biaxial birefringent material that provides high reflectivity for light with its plane of polarization parallel to one axis, for a broad range of angles of incidence, and simultaneously have low reflectivity and high transmission for light with its plane of polarization parallel to the other axis for a broad range of angles of incidence. As a result, the film acts as a polarizer, transmitting light of one polarization and reflecting light of the other polarization.

In many applications, the reflecting polarizer has high reflectance along one axis (the so-called extinction axis) and zero reflectance along the other (the so-called transmission axis), at all angles of incidence. For the transmission axis of a polarizer, it generally desirable to maximize transmission of light polarized in the direction of the transmission axis over the bandwidth of interest and also over the range of angles of interest.

Average transmission at normal incidence for a narrow bandpolarizer across a 100 nm bandwidth is desirably at least 50%, preferably at least 70% and more preferably at least 90%. The average transmission at 60 degrees from the normal for p-polarized light (measured along the transmission axis) for a narrow band polarizer across a 100 nm bandwidth is desirably at least 50%, preferably at least 70% and more preferably at least 80%.

The average transmission at normal incidence for a polarizer in the transmission axis across the visible spectrum (400-700 nm for a bandwidth of 300 nm) is desirably at least 50%, preferably at least 70%, more preferably at least 85%, and even more preferably at least 90%. The average transmission at 60 degrees from the normal (measured along the transmission axis) for a polarizer from 400-700 nm is desirably at least 50%, preferably at least 70%, more preferably at least 80%, and even more preferably at least 90%.

For certain applications, high reflectivity in the transmission axis at off-normal angles is preferred. The average reflectivity for light polarized along the transmission axis should be more than 20% at an angle of at least 20 degrees from the normal.

An illustrative reflective polarizer is made of alternating layers (ABABA . . . ) of two different polymeric materials, referred to as material “(A)” and material “(B)”. The two materials are extruded together and the resulting multiple layer (ABABA . . . ) material is stretched (5:1) along one axis (X), and is not stretched appreciably (1:1) along the other axis (Y). The X axis is referred to as the “stretched” direction while the Y axis is referred to as the “transverse” direction.

The (B) material has a nominal index of refraction (n=1.64 for example) which is not substantially altered by the stretching process. The (A) material has the property of having the index of refraction altered by the stretching process. For example, a uniaxially stretched sheet of the (A) material will have one index of refraction (n=1.88 for example) associated with the stretched direction and a different index of refraction (n=1.64 for example) associated with the transverse direction.

In general, appropriate combinations may be achieved by selecting, as the first material, a crystalline or semi-crystalline material, preferably a polymer. The second material, in turn, may be crystalline, semi-crystalline, or amorphous. The second material may have a birefringence opposite to or the same as that of the first material. Or, the second material may have no birefringence.

Preferred combinations of layers in the case of polarizers include PEN/co-PEN, polyethylene terephthalate (PET)/co-PEN, PEN/sPS, PET/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co.

Although the reflective polarizer has been discussed with an exemplary multiple layer construction that includes alternating layers of only two materials it should be understood that the reflective polarizer may take a number of forms. For example, additional types of layers may be included into the multiple layer construction. Also in a limiting case, the reflective polarizer may include a single pair of layers (AB) one of which is stretched. Furthermore, a dichroic polarizer could be bonded directly to reflective polarizer.

The polarizing film usually has a smooth surface, but can be provided with an irregular surface as far as the effect of the present invention is not adversely affected. In this case, the convex portion can be formed by a matting or embossing treatment so as to afford the same effect as that of the diffusive film. In this case, the outer-most layer of the polarizing film can also be regarded as the diffusive film by eliminating the separate diffusive film disposed closely to this surface.

The number of polarizing films included in the polarizing layer is usually one, but a plurality of films can also be included. Furthermore, a film or layer other than the polarizing film may be included as far as the effect of the present invention is not adversely affected. The film or layer includes, for example, a surface protective layer, antistatic layer, transparent supporting layer (for the purpose of enhancing its strength), magnetic shield layer, adhesive layer, primer layer and the like. The thickness of the entire polarizing layer should be selected so that the resulting optical laminated body does not become bulky, and is usually from 5 to 2,000 μm.

Examples of polarizing films include those described in U.S. Pat. Nos. 5,825,543 and 5,783,120, each incorporated herein by reference. The use of these polarizer films in combination with a brightness enhancement film has been described in U.S. Pat. No. 6,111,696; incorporated herein by reference. Another example of a polarizing film is described in U.S. Pat. No. 5,882,774; incorporated herein by reference. Multilayer polarizing films are sold by 3M Company, St. Paul, Minn. under the trade designation DBEF (Dual Brightness Enhancement Film). The use of such multilayer polarizing optical film in a brightness enhancement film has been described in U.S. Pat. No. 5,828,488; incorporated herein by reference

Various diffusive layers are suitable for use in the laminated optical article of the invention, such as layers 22 and 23 as depicted in FIG. 1.

A diffusive film typically includes a diffusive surface treatment created by matting or embossing. It can also be formed by subjecting the surface to the other diffusion surface treatment such as sandblasting or arrangement of a plurality of micro-projections. Furthermore, the diffusive film may contain diffusive particles provided the intended optical properties are not adversely affected. It is appreciated that certain diffusive films provide some collimation of light.

The first and second transparent films (i.e. first and second diffusive films) may be the same or different. For example, a diffusive film wherein at least one surface (principal surface) is subjected to a diffusion surface treatment is used as the first and second diffusive films and, furthermore, one diffusive film is closely disposed to the surface of the polarizing layer so that a light-entrancing-surface (an opposite surface to a surface contacting closely to the polarizing layer) of the first transparent film becomes a diffused surface, while the other diffusive film is closely disposed to the back surface of the polarizing layer so that a light emitting surface (an opposite surface to a surface contacting closely to the polarizing layer) of the second transparent film becomes a diffused surface.

The diffusive surface can be formed, for example, by using a resin composition comprising a resin such as a polycarbonate resin, acrylic resin, polyester resin, epoxy resin, polyurethane resin, polyamide resin, polyolefin resin, silicone resin (including modified silicone such as silicone polyurea) or the like.

The diffusive film is preferably a film subjected to a diffusion surface treatment. In this case, transmission loss by absorption in the diffusive film can be effectively prevented and it becomes easier to enhance the illuminance or brightness of the illuminating body. For example, the transmittance of the film before subjecting to the diffusion surface treatment (i.e. material itself of the diffusive film) is usually not less than 85%, preferably not less than 90%, and particularly preferably not less than 95%.

The diffusion performance of the diffusive film is not specifically limited as far as the effect of the present invention is not adversely affected. For example, the haze of the diffusive film is usually from 40 to 90%, preferably from 45 to 87%, and particularly preferably from 50 to 85%. The roughness (Ra: centerline average roughness) of the diffused surface is usually less than 30 μm, and preferably not more than 20 μm.

The optical articles of the invention (e.g. intermediates, laminated optical article) may be employed in various display devices such a liquid crystal displays (LCDs) for mobile telephones, hand-held computer devices such as personal data assistants (PDAs) and electronic games, as well as laptop computers, LCD monitors and television screens.

An illustrative display that may be particularly useful for LCD television screens and other large displays are schematically illustrated in FIG. 2. In the display 400 illustrated in FIG. 2, light 402 is generated by one or more light sources 404. The light sources 404 may be any suitable type of light source, or combination of light sources, that achieves the desired color in the illuminating light 402. Examples of light sources include cold cathode fluorescent tubes, light emitting diodes and the like. A reflector 405 may be positioned behind the light sources 404 to reflect light that is emitted away from the display back towards the display. The reflector 405 may be a diffuse reflector so as to help make the illumination of the display more uniform. The reflector 405 may take one of several different forms, including that of a sheet reflector placed below the light sources 404 and also that of a reflecting box or cavity (illustrated) with reflecting surfaces along the side. The reflector 405 need not be flat, and may have a desired shape.

The light 402 enters a diffusing plate 406, which is used to diffuse the light so that the viewer perceives uniform image brightness across the display 400. The diffusing plate 406 may be a few millimeters thick to provide rigidity, and may contain diffusing particles. The diffusing plate 406 may be formed of any suitable material, for example polycarbonate or poly methyl methacrylate (PMMA).

After passing through the diffusing plate 406, the light has a wide viewing angle. Television screens typically use a wide horizontal viewing angle so that viewers may be able to see the image from a wide range of angles relative to the screen normal. The vertical viewing angle, on the other hand is typically less than the horizontal viewing angle, since the vertical position of the viewers relative to the screen normal is usually spread over a much smaller range than the horizontal spread. Therefore, it is advantageous to reduce the vertical viewing angle relative to the horizontal viewing angle, which results in the image becoming brighter. A layer of prismatic brightness enhancing film 408 may be used to reduce the vertical viewing angle of the light that has passed through the diffusing plate 406. An air gap may be present between the film 408 and the diffusion plate 406, or there may be intervening layers between the film 408 and the plate 406.

The LCD 416 usually includes a layer of liquid crystal 418 sandwiched between first and second absorbing polarizers 420 and 422. The light 402 from the light sources 404 is typically unpolarized, so a laminated optical article 2 comprising a reflective polarizer 21 adhesively bonded with adhesive layers 25 and 24 between two diffusive films 22 and 23, may be inserted between the brightness enhancing layer 408 and the LCD 416 to recycle the light in the polarization state that would otherwise be absorbed in the second absorbing polarizer 422. The light reflected by the reflective polarizer 21 may subsequently have its polarization rotated, at least partially, for example through diffuse reflection or by passing through a polarization rotating element (not shown). When it is returned to the reflective polarizer 21, at least a portion of the reflected light is in the polarization state that is transmitted reflecting polarizer 22 and the second absorbing polarizer 422.

Light that has passed through the laminated optical article 2 is then directed to the LCD 416, which imposes an image on the light passing to the viewer. The second absorbing polarizer 422 may remain separated from the laminated optical article 2 (not shown), or may be adhered with the adhesive described herein. The outer surface 424 of the first absorbing polarizer 420 may be treated with one or more surface treatments. For example, the outer surface 424 may be provided with a matte finish or an anti-glare coating. The outer surface 424 may also be provided with a hard coating to provide protection against scratching.

Additional diffusion may be provided within the screen 400, in addition to that provided in the diffusion plate 406, such as by the diffusive films layers 22 and 23 of the laminated optical article.

It will be appreciated that additional layers and/or surface treatments may be used in any of the described displays. For example, the upper surface of the laminated optical article may be a matte surface so as to increase light diffusion and thus increase the uniformity of the illumination of the light. One or more layers of the displays may be provided with an antistatic coating, for example a thin layer of electrically conductive material. One example of a suitable conductive material is indium tin oxide (ITO), although other conductive materials, such as conducting polymers, may be used.

Advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLE

Test Methods

1. Refractive Index of the uncured adhesive compositions (referring to the absolute refractive index of a material that is understood to be the ratio of the speed of electromagnetic radiation in free space to the speed of the radiation in that material) was measured using an Abbe refractometer in the visible light region (commercially available from Fisher Instruments of Pittsburgh, Pa.). It is generally appreciated that the measured index of refraction can vary to some extent depending on the instrument.

2. Color Stability

The yellowness color of the laminated optical article in the 1976 CIE L* a* b* color space, (b*(t-0), was measured using a BYK Gardner Colorsphere with a 400 nm to 700 nm light source. The laminated optical articles samples were subjected to accelerated aging by exposing the samples to spectral irradiance for 300 hours with use of an accelerated light stability device commercially available from Q-Panel Lab Products, Cleveland, Ohio equipped with a fluorescent ultraviolet lamp commercially available from Philips Lighting Co., Somerset, N.J. under the trade designation “Philips F40/50U/ALTO Lamps” at a black panel temperature of 90° C. The change in yellowness (i.e. change in b*) is the difference between the yellowness before exposure in comparison to after exposure.

3. Transmission

The transmittance of the laminated optical articles was also measured using the BYK Gardner Colorsphere with a 400 nm to 700 nm light source.

4. Haze

Haze of the laminated optical articles was measured using the BYK Gardner Haze-Guard plus. Haze is measured by locating the sample surface perpendicularly to the illuminated light source. Transmitted light is measured photo electrically using an integrating sphere (0°/Diffuse geometry) resulting in a haze measurement

5. Gain

Gain of the laminated optical articles was measured on an instrument commercially available from Photo Research, Inc, Chatsworth, Calif. under the trade designation “SpectraScan PR-650 SpectraColorimeter”. Results of this method for each example formed below are reported in the RESULTS section below. Samples of the indicated optical articles were cut and placed on a Teflon light cube that is illuminated via a light-pipe using a Foster DCR II light source.

6. T-Peel Adhesion

A 12.7 mm (one half inch) wide by about 152 mm (6 inches) long sample of the indicated optical article was cut on a 0 degree bias in the down web direction from the article to be tested and placed in an Instron tensile tester for a T-peel. The test were run at 12 inches per minute and reported in lb per inch. The test was allowed to run for 24 seconds, unless the substrate broke during the test.

7. Stiffness

The stiffness of the laminated optical articles was measured using an Instron tensile tester according to ASTM D790—3 Point Bend Test. The span used for the 3 Point Bend test was 8.79 mm (0.346 inches) and the traverse speed was 0.5 mm/min (0.02 inch/min). The diameter of the support mandrels was 4 mm (0.157 inches) and the center mandrel was 10 mm (0.393 inches). A 25.4 mm (one inch) wide by about 152 mm (6 inches) long sample was cut on a 90 degree bias to the down web direction from the article to be tested and placed in an Instron tensile tester for a stiffness test.

The values reported for each of the test methods is as an average of three samples unless reported otherwise

### INGREDIENTS EMPLOYED IN THE EXAMPLES

Nitrogen-Containing Polymer

E-335 is a linear, random copolymer of vinylpyrrolidone and vinyl acetate (at 30/70 molar ratio) obtained from International Specialty Products under the trade designation “PVPNA E-335”. The polymer is obtained in ethanol at about 50% solids. The Mw as measured with a polyethylene oxide standard is about 28,800 g/mole with a polydispersity of about 5, and glass transition temperature about 69° C. Typical residual monomers are at <100 ppm for vinylpyrrolidone and <300 ppm for vinyl acetate.

LP is a homopolymer of vinylcaprolactam obtained from the Final Chemical Div. of BASF Co. (Mount Olive, N.J.) under the trade designation “Luviskol Plus”. The polymer is obtained in ethanol at about 40% solids. It has a K value (molecular weight) in the range of 40-46, and glass transition temperature about 155° C. Typical residual vinylcaprolactam monomer is less than 20 ppm.

VA 64 is a copolymer of vinylpyrrolidone and vinyl acetate (at 40/60 weight ratio) obtained from the Final Chemical Div. of BASF Co. (Mount Olive, N.J.) under the trade designation “Luvitec Va. 64”. The polymer is obtained in dry solid form with a K value in the range of 30±4, and glass transition temperature at about 70° C. Typical residual monomers are at <100 ppm for vinylpyrrolidone and <300 ppm for vinyl acetate.

PEOX is a homopolymer of ethyloxazoline obtained from International Specialty Productsunder the trade designation “Aquazol 50”. The polymer is obtained in the powder form. It has a target molecular weight of 50,000 g/mole, a glass transition temperature of 69-71° C., and refractive index of 1.520.

SIMD is a copolymer of (Stearyl Methacrylate/Isobutyl Methacrylate/Methyl Methacrylate/Dimethylaminoethyl methacrylate at respective weight ratio of 10/20/20/50. This polymer was prepared by regular solution polymerization using a 2,2′-Azobis(2-methylbutanenitrile) thermal radical initiator commercially available from Du Pont under the trade designation “Vazo-67”. in ethanol at 50% monomer concentration. The polymer was dried under reduced pressure at 65° C.

Poly(acrylonitrile-butadiene-styrene) polymer was obtained from Dow Plastics (Midland, Mich.) under the trade designation “MAGNUM 555”.

Poly(acrylonitrile-styrene) was obtained from Dow Plastics (Midland, Mich.) under the trade designation “TYRIL 880”.

Poly(acrylonitrile-styrene) was obtained from Dow Plastics (Midland, Mich.) under the trade designation “TYRIL 100”.

| | Trade Designation, Supplier, | | |
|---|---|---|---|
| Generic Chemical Description | Location | Abbreviation | Function |
| Phenoxy ethyl acrylate | “Ageflex PEA”, CIBA | Ageflex PEA | Polymerizable |
| | | | Monomer |
| | | | Diluent |
| Phenoxy ethyl acrylate | “Etermer 210”, Eternal | Etermer 210 | Polymerizable |
| | Chemicals | | Monomer |
| | | | Diluent |
| Phenoxy ethyl acrylate | “Sartomer SR 339” | SR 339 | Polymerizable |
| | | | Monomer |
| | | | Diluent |
| Phenoxy ethyl acrylate | “Photomer 4035”, Cognis | Photomer 4035 | Polymerizable |
| | | | Monomer |
| | | | Diluent |
| Alkoxylated THF Acrylate | “Sartomer CD 611” | CD611 | Polymerizable |
| | | | Monomer |
| | | | Diluent |
| Tetrahydrofurfuryl Acrylate | “Sartomer SR-285” | SR285 | Polymerizable |
| | | | Monomer |
| | | | Diluent |
| Ethoxylated Bisphenol A | “Sartomer CD9038” | CD9038 | Crosslinking |
| Diacrylate (EBDA) | | | Agent |
| Diphenyl(2,4,6- | “Lucrin TPO”, BASF | TPO | Initiator |
| trimethylbenzoyl)Phosphine | | | |
| Oxide | | | |
| Hindered phenol | Irganox 1010, CIBA | Irganox 1010 | Stabilizer |
| Aliphatic Urethane Diacrylate | Ebecryl 270, UCB Radcure | E-270 | Crosslinking |
| | | | Agent |

Following are illustrative adhesive compositions of the invention that were utilized to bond various substrates and prepare various (e.g. optical) articles of the invention. For each adhesive composition the ingredients are identified followed by the respective weight percentage of each ingredient. For example, “Ageflex PEA/LP/CD9038/TPO =80/10/10/1.0” refers to 80 wt-% Ageflex PEA, 10 wt-% LP, 10 wt-% CD9038 and 1.0 wt-% TPO. For the exemplified embodiments, the adhesive compositions are 100% solids and substantially free of solvent. All the exemplified adhesive compositions have a residual nitrogen-containing monomer content of less than 25 ppm.

Adhesive Composition 1: Ageflex PEA/LP/CD9038/TPO =80/10/10/1.0 To a 5-gallon plastic container (tare weight: 1241 g) were charged the following materials: Ageflex PEA (6400 g), dried LP polymer (800 g, dried) and Sartomer CD9038 (800 g). The sample was mixed at ambient temperature until all dissolved (about three days). TPO initiator (80.0 g) was added to this solution followed by dissolving it in absence of light. This sample was measured for Brookfield viscosity (171 cps) and Refractive Index (1.5175, at 25° C.).

Adhesive Composition 2: Ageflex PEA/LP/CD9038/TPO/Irganox 1010=80/10/10/1.0/0.5 was prepared in the same manner as Adhesive Composition 1 except that the composition included 0.5 parts Irganox 1010. This sample was measured for Brookfield viscosity (190 cps) and refractive index (1.5183, at 25° C.).

Adhesive Composition 3: Etermer 210/E-335/CD9038/TPO/Irganox 1010=75/15/10/1.0/0.5 To a three-liter flask were added Etermer 210 (1125 g) and E-335 (445 g). The sample was stripped off of solvent under reduced pressure at 50° C. A total of 213 g of solvents were stripped out. The stripped sample was poured into a 5-gallon pail (tare weight: 1256 g). This entire process was repeated three more times as described in the table below producing three additional samples.

| | Flask | Etermer | VP/VA | Solvents |
|---|---|---|---|---|
| Example 3 | Tare, g | 210, g | E-335, g | Stripped, g |
| 1 | 755 | 1125 | 445 | 213 |
| 2 | 762 | 1125 | 445 | 215 |
| 3 | 442 | 1125 | 445 | 202 |
| 4 | 757 | 1500 | 593 | 280 |

All four samples were combined in the 5-gallon pail weighed 5733 g net. To this sample was added Sartomer CD9038 (637 g), Lucirin TPO (63.7 g) and Irganox 1010 (32.0 g) to make the final formulation. This sample was further mixed for a few hours to ensure that everything was dissolved and fully mixed. This sample was measured for its Brookfield viscosity (353 cps) and refractive index (1.5111 at 25° C.).

Adhesive Composition 4: Ageflex PEA/E-335/CD9038/TPO =75/15/10/1.0

To a three-liter flask were added Ageflex PEA (1125 g) and E-335 (445 g) solution as being described in the following table. The samples were stripped off of solvents under reduced pressure at 50° C. A total of 213 g of solvent was stripped out. The stripped sample was poured into a 5-gallon pail (tare weight: 1258 g). This entire process was repeated four more times as described below producing four additional samples.

| | Flask | Ageflex | VP/VA | Solvents |
|---|---|---|---|---|
| Example 4 | Tare, g | PEA, g | E-335, g | Stripped, g |
| 1 | 442 | 1125 | 445 | 213 |
| 2 | 456 | 1125 | 445 | 207 |
| 3 | 757 | 1500 | 593 | 283 |
| 4 | 756 | 1500 | 593 | 273 |
| 5 | 773 | 1500 | 593 | 282 |

The net weight of the five combined samples was 8146 g. To this pail were added Lucirin TPO (90.5 g) and Sartomer CD9038 (905 g). This sample was further mixed for a few hours to ensure that everything was dissolved and fully mixed. This sample was measured for its Brookfield viscosity (303 cps) and refractive index (1.5120 at 25° C).
Adhesive Composition 5: SR339/PEOX/CD61 1I/E-270/CD9038/TPO =65/10/15/5/5/1

Sartomer 339 (65.0 g) was mixed with PEOX (10.0 g) in a glass jar, and the mixture was rolled at room temperature for about 30 hours to dissolve the polymer to a clear solution. To this sample was added CD 611 (15.0 g), Ebecryl 270 (5.0 g), and CD9038 (5.0 g). The sample was shaken for a few hours at ambient temperature to a homogeneous solution. To this solution was then added TPO (1.0 g, 1.0% based on total weight) and the sample was rolled in absence of light overnight to dissolve all the initiator.

Adhesive Composition 6: SR339/SIMD/CD611 /E-270/CD9038/TPO =60/15/15/5/5/1

A copolymer of (Stearyl Methacrylate/Isobutyl Methacrylate/Methyl Methacrylate/Dimethylaminoethyl methacrylate =10/20/20/50, SIMD), prepared by regular solution polymerization, was dried. Ageflex PEA (60.0 g) was mixed with this polymer. The sample was rolled overnight at ambient temperatures until a clear solution was obtained. To this sample was added CD 611 (15.0 g), Ebecryl 270 (5.0 g), and CD 9038 (5.0 g). The sample was shaken for a few hours at ambient temperature to a homogeneous solution. To this solution was further added TPO (1.0 g, 1.0% based on total weight) and the sample was rolled in absence of light overnight to a clear solution.

Table I as follows describes addition adhesive compositions of the invention prepared in the same general manner as Adhesive Compositions 1-6.

TABLE 1
Illustrative Adhesive Compositions of the Invention

| | | | Refractive |
|---|---|---|---|
| Example | Composition | Observations | Index |
| 7 | Ageflex PEA/LP/CD9038/TPO = 8010/10/1.0/ | Clear Solution | 1.5175 |
| 8 | Ageflex | Clear Solution | 1.5183 |
| | PEA/LP/CD9038/TPO/Irganox1010 = 80/10/10/ | | |
| | 1.0/0.5 | | |
| 9 | Etemer 210/E- | Clear Solution | 1.5111 |
| | 335/CD9038/TPO/Irganox1010 = 75/15/10/ | | |
| | 1.0/0.5 | | |
| 10 | Ageflex PEA/E-335/CD9038/TPO = 75/ | Clear Solution | 1.5120 |
| | 15/10/1.0 | | |
| 11 | SR339/PEOX/CD611/E- | Clear Solution | NM |
| | 270/CD9038/TPO = 65/10/15/5/5/1 | | |
| 12 | SR339/SIMD/CD611/E- | Clear Solution | NM |
| | 270/CD9038/TPO = 60/15/15/5/5/1 | | |
| 13 | Ageflex PEA/VA64/E-270/TPO = 80/ | Clear Solution | 1.5085 |
| | 10/10/1.0 | | |
| 14 | SR339/LP/E-270/CD9038/TPO = 75/ | Clear Solution | 1.5170 |
| | 15/5/5/1.0 | | |
| 15 | SR339/LP/CD611/TPO = 70/ | Clear Solution | 1.5060 |
| | 15/15/1.0 | | |
| 16 | Ageflex PEA/LP/TPO = 90/10/1.0 | Clear Solution | 1.5196 |
| 17 | Ageflex PEA/LP/TPO = 85/15/1.0 | Clear Solution | 1.5204 |
| 18 | Ageflex PEA/LP/TPO = 80/20/1.0 | Clear Solution | 1.5213 |
| 19 | Ageflex PEA/LP/TPO = 75/25/1.0 | Clear Solution | 1.5223 |
| 20 | Ageflex PEA/VA64/CD9038/TPO = 65/ | Clear Solution | 1.5151 |
| | 25/10/1.0 | | |
| 21 | Photomer 4035/E-335/TPO = 80/ | Clear Solution | 1.5120 |
| | 20/1.0 | | |
| 22 | Photomer 4035/E-335/CD9038/TPO = 70/ | Clear Solution | NM |
| | 20/10/1.0 | | |
| 23 | Photomer 4035/E- | Clear Solution | NM |
| | 335/CD9038/TPO/Irganox 1010 = 70/ | | |
| | 20/10/1.0/0.5 | | |
| 24 | Ageflex | Clear Solution | 1.5193 |
| | PEA/LP/CD9038/TPO/Irganox 1010 = 80/ | | |
| | 10/10/1.5/0.25 | | |
| 25 | Ageflex PEA/E-335/TPO/Irganox | Clear Solution | 1.5153 |
| | 1010 = 85/15/1.5/0.25 | | |
| 26 | PEA/Tyril 100/TPO/Irganox 1010 = 85/ | Clear viscous | 1.5300 |
| | 15/1.5/0.25 | soln. | |
| 27 | PEA/Tyril 880/TPO/Irganox 1010 = 85/ | Clear viscous | 1.5289 |
| | 15/1.5/0.25 | soln. | |
| 28 | PEA/Magnum 555/TPO/Irganox | Clear viscous | 1.5283 |
| | 1010 = 85/15/1.5/0.25 | soln. | |
| 29 | PEA/Tyril 100/TPO/Irganox 1010 = 90/ | Clear soln. | 1.5272 |
| | 10/1.5/0.25 | | |
| 30 | PEA/Tyril 880/TPO/Irganox 1010 = 90/ | Clear soln. | 1.5258 |
| | 10/1.5/0.25 | | |
| 31 | PEA/Magnum 555/TPO/Irganox | Clear soln. | 1.5253 |
| | 1010 = 90/10/1.5/0.25 | | |

NM = not measured

Preperation of Articles from the Adhesive Compositions

The laminated optical article as depicted in FIG. 1 were prepared by concurrently coating two layers of adhesives (i.e. 24 and 25 of FIG. 1) between three films layers (i.e. between 21 and 22, and between 21 and 23 of FIG. 1) using a gap coater with the gap set at 1.25 mils for each adhesive layer. A 5.2 mil polarizing film having outer surface layers comprised of PEN, commercially available from 3M Company, St. Paul, Minn. under the ignation “Vikuiti DBEF-E”, was employed as the polarizing layer (i.e. 21 of FIG.

1). Polycarbonate films (PC) having a thickness of 5.1 mils, a birefringence of less than 30 nm, a haze of at least 50% and a transmission of at least 80% were employed as the diffusive film layers (i.e. 22 and 23 of FIG. 1). The adhesive coated films were substantially fully cured with ultraviolet light exposure. A suitable ultraviolet curing system can be obtained from Fusion UV System, Inc. such as the Fusion UV Systems F600 series Fusion bulbs with a reflector assembly and a Model 6 VPS power source. The conveyor and the lamp reflector system were set up so the sample passes through a line of focus of the UV light to give UVA, UVB, and UVC intensities of 0.2 to 7 W/cm² depending upon the type of UV lamp used (D-bulb or H-bulb). UVA, UVB, and UVC doses where measured on such equipment and found to be in the range of 0.5 to 2 J/cm, depending on whether an H-bulb or D-bulb was used and depending upon the linear speed of the conveyor. The conveyor line was run at 25 feet per minute, unless otherwise indicated, for the examples given in Tables 2, 3, and 4. Comparative Examples A and B were exposed to a low intensity lamp prior to the high intensity exposure just described in addition to using slower line speeds in order to fully cure the samples.

A second laminate was prepared by the same method just described with the exception that a 3.8 mil polarizing film having outer surface layers comprised of PEN, commercially available from 3M Company, St. Paul, Minn. under the trade designation “Vikuiti DBEF-Q”, was employed as the polarizing layer (i.e. 21 of FIG. 1).

A third laminate was prepared by the same method as the second laminate with the exception that 8 mil PC films having the same a birefringence, haze, and transmission were employed in place of the 5.1 mil polycarbonate films.

A fourth laminate was prepared by bonding 5.1 mil PEN film commercially available from Tekra Corporation, New Berlin, Wis. under the trade designation “005 TEOX Q51” to the 5.1 mil polycarbonate film using the same curing conditions.

A fifth laminate was prepared by bonding the 5.2 mil polarizing film (Vikuiti DBEF-E) to the 5.1 mil polycarbonate film using the same curing conditions.

A sixth laminate was prepared using a number 10 Meyer bar to provide a 1 mil coating of the adhesive on a glass plate commercially available from Viratec Thin Films, Inc., Fairbault, Minn., under the trade designation “CDARR/CFL.16/NONE”. The “Vikuiti DBEF” film was then placed upon the curable composition taking care not to allow the resin to flow. The glass, curable adhesive composition, and Vikuiti DBEF film were then exposed twice to a UV H-bulb at 20 feet per minute conveyor speed as described above.

Table 2A shows the optical properties of the laminate in comparison commercially available laminate optical article having the same film layers except a different adhesive composition. Comparatives Example A and B employed a polymerizable adhesive composition believe to contain a polymerizable nitrogen containing acrylate monomer and nitrogen-free polymerizable acrylate monomers.

TABLE 2A
Optical Properties of Laminated Optical Article

| | Adhesive | Mean | StDev |
|---|---|---|---|
| Color Stability: Change in b * (t − 0) | 1 | 0.36 | 0.04 |
| | 2 | 0.46 | 0.08 |
| | 3 | 0.73 | 0.03 |
| Comparative A | | 2.1 | 0.25 |
| Comparative B | | 3.37 | 0.04 |
| Initial Gain | 1 | 1.63 | 0.01 |
| | 2 | 1.64 | 0 |
| | 3 | 1.64 | 0.01 |
| Comparative A | | 1.63 | 0.01 |
| Comparative B | | 1.65 | 0.01 |
| Initial % Transmission | 1 | 49.47 | 0.38 |
| | 2 | 50.47 | 0.29 |
| | 3 | 49.9 | 0.17 |
| Comparative A | | 49.87 | 0.38 |
| Comparative B | | 49.8 | 0.1 |
| Initial % Haze | 1 | 80.83 | 0.38 |
| | 2 | 80.87 | 0.92 |
| | 3 | 79.63 | 0.15 |
| Comparative A | | 81.57 | 0.06 |
| Comparative B | | 80.80 | 0.20 |

Table 2A demonstrates that the inital optical properties of the laminate optical article of the invention are about the same as Comparative A and Comparative B. However, the laminated optical articles of the invertion exhibit improved color stability as indicated by smaller change in b* values.

TABLE 2B
Stiffness Property of Laminated Optical Articles

| | | Stiffness | | |
|---|---|---|---|---|
| | | lbs-force per | | |
| | | inch width | | |
| | | per inch | | |
| | | thickness | | |
| Laminate | Adhesive | (lb-f/in²) | Stdv | Line speed |
| Laminate 1 | 24 | 151.97 | 1.99 | 20 fpm |
| | 25 | 99.30 | 2.79 | 20 fpm |
| | Comparative A | 61.50 | 0.65 | 12 fpm |
| Laminate 2 | 24 | 125.62 | 0.84 | 12 fpm |
| | 24 | 119.85 | 3.18 | 20 fpm |
| | 25 | 97.79 | 1.16 | 12 fpm |
| | 25 | 75.81 | 1.07 | 20 fpm |
| | Comparative A | 55.95 | 0.85 | 12 fpm |
| Laminate 3 | 24 | 311.70 | 5.99 | 12 fpm |
| | 25 | 269.00 | 15.20 | 12 fpm |
| | 25 | 191.300 | 14.100 | 20 fpm |
| | Comparative B | 125.08 | 7.70 | 12 fpm |
| 3.8 mil DBEF | | 3.81 | 0.09 | |
| 8 mils PC | | 20.56 | 0.90 | |
| 5.1 mils PC | | 5.39 | 0.10 | |

Table 2B demonstrates that the laminated optical articles of the invention exhibit improved stiffness attributed at least in part by the adhesive. In at least some embodiments, Laminate 2, employing a thinner polarizing layer has comparable stiffness to Laminate 1.

TABLE 3
T-Peel Adhesion of PEN Film Adhered to PC Film (Fourth Laminate)

T-Peel Adhesion
Avg. Load (lbs/in
width)

| Adhesive | Avg | St Dev |
|---|---|---|
| 11 | 3.47 | 0.18 |
| 12 | 2.78 | 0.11 |
| 13 | 7.22 | 0.53 |
| 14 | 4.26 | 0.24 |
| 15 | 3.41 | 0.17 |
| 16 | 6.69 | 2.56 |
| 17 | 2.52 | 0.23 |
| 18 | 1.07 | 0.39 |
| 19 | 0.79 | 0.42 |
| 20 | 5.87 | 0.16 |
| 21 | 2.27 | 0.38 |
| 22 | 4.15 | 0.07 |
| Comp. A | 4.5 | 0.3 |
| 26 | 0.15 | 0.08 |
| 27 | 0.61 | 0.10 |
| 28 | 0.87 | 0.16 |
| 29 | 1.16 | 0.23 |
| 30 | 1.13 | 0.27 |
| 31 | 2.35 | 1.22 |

TABLE 4
T-Peel Adhesion of Vikuiti DBEF adhered to PC (Fifth Laminate)

| | T-Peel Adhesion |
|---|---|
| | Avg. Load |
| Adhesive | (lb/inch width) |
| 13 | 1.549 |
| 14 | 2.033 |
| 15 | 6.379 |
| 16 | 0.644 |
| 17 | 0.874 |
| 18 | 0.198 |
| 19 | 1.044 |
| 20 | 3.179 |
| 21 | 5.001 |
| 22 | 4.265 |
| Comp A | 7.407 |

(only 1 pull per sample - no StDev)

TABLE 5
T-Peel Adhesion for Vikuiti DBEF Adhered to Glass Plates (Sixth
Laminate)

T-Peel Adhesion (lbs/inch width)

| Adhesive | Average | StDev |
|---|---|---|
| 24 | 3.43 | 0.39 |
| 25 | Strength of adhesion was | |
| | greater than substrate | |
| | strength. Substrate broke | |
| | during testing | |

What is claimed is:

1. An adhesive composition comprising
at least one ethylenically unsaturated polymerizable diluent, and
at least one nitrogen-containing polymer.

2. The adhesive composition of claim 1 wherein the nitrogen-containing polymer is a homopolymer or copolymer of a moderately polar Lewis base-functional copolymerizable monomer.

3. The adhesive composition of claim 1 wherein the nitrogen-containing polymer is soluble in the diluent.

4. The adhesive composition of claim 1 wherein the nitrogen-containing polymer is selected from the group consisting of homopolymers and copolymers of vinylcaprolactam, ethyloxazoline homopolymers, vinylpyrrolidone copolymers, acrylonitrile-styrene copolymers, acrylonitrile-butadiene-styrene copolymers, and copolymers of nitrogen containing acrylates.

5. The adhesive composition of claim 1 wherein the nitrogen-containing polymer is free of ethylenically unsaturated polymerizable groups.

6. The adhesive composition of claim 1 wherein the adhesive composition has a residual nitrogen-containing monomer content of less than 25 ppm.

7. The adhesive composition of claim 1 wherein the ethylenically unsaturated polymerizable diluent comprises at least one (meth)acrylate group.

8. The adhesive composition of claim 1 wherein the ethylenically unsaturated polymerizable diluent is selected from a monomer, an oligomer, a prepolymer and mixtures thereof.

9. The adhesive composition of claim 1 wherein the amount of ethylenically unsaturated polymerizable diluent ranges from about 40 wt-% to about 95 wt-%.

10. The adhesive composition of claim 1 wherein the ethylenically unsaturated polymerizable diluent is monofunctional.

11. The adhesive composition of claim 1 wherein the composition further comprises at least one crosslinking agent.

12. The adhesive composition of claim 1 wherein the adhesive composition further comprises about 0.1 wt-% to about 5 wt-% of photoinitiator.

13. The adhesive composition of claim 1 wherein the adhesive has a refractive index ranging from about 1.50 to 1.55.

14. The adhesive composition of claim 1 wherein the adhesive exhibits a change in b* of less than 2 after accelerated aging.

15. A method of making an article comprising:
applying an adhesive composition to a first substrate wherein the adhesive composition comprises at least one ethylenically unsaturated polymerizable diluent and at least one nitrogen-containing polymer;
contacting the adhesive composition with a second substrate; and
polymerizing the composition such that a bond is formed between the first substrate and second substrate.

16. The method of claim 15 wherein the first and second substrates are independently polymeric films.

17. The method of claim 15 wherein at least one substrate comprises poly(ethylene naphthalate) at least at the surface.

18. The method of claim 15 wherein the adhesive composition further comprises an initiator.

19. The method of claim 15 wherein the composition is polymerized by photocuring.

20. The method of claim 15 wherein the bond exhibits a T-peel of at least about 0.35 lbs/inch width.
